(19) United States
(12) Patent Application Publication
(10) Pub. No.: US 2019/0346588 A1
(43) Pub. Date: Nov. 14, 2019

(54) BUILDING OCCUPANT SENSING USING FLOOR CONTACT SENSORS

(71) Applicant: OTIS ELEVATOR COMPANY, Farmington, CT (US)

(72) Inventor: Arthur Hsu, South Glastonbury, CT (US)

(21) Appl. No.: 15/973,819

(22) Filed: May 8, 2018

(51) Int. Cl. G01V 9/00; B66B 1/46; B66B 25/00; B66B 1/24; G05B 15/02

(52) U.S. Cl. CPC G01V 9/00; B66B 1/468; B66B 25/003; B66B 2201/4638; G05B 15/02; B66B 2201/20; B66B 1/2408

(57) ABSTRACT

An occupancy detection system is provided. Aspects includes a controller and a plurality of floor contact sensors configured to collect sensor data from one or more predefined floor areas, wherein the controller is configured to determine a presence of a potential occupant based at least in part on the sensor data, wherein the sensor data comprises a movement pattern of the potential passenger. The movement pattern of the potential occupant is analyzed to calculate a likelihood score that the potential occupant will use an occupancy area. And based at least in part on the likelihood score being above a threshold score, a confirmation signal is transmitted to an occupancy area controller.

### BACKGROUND

The subject matter disclosed herein generally relates to occupancy detection systems and, more particularly, to building occupant sensing using floor contact sensors.

Pressure mats have been used for some time to detect the presence of a person, for example, for automatic doors or for sensing someone on a landing plate near an escalator. These pressure sensors typically require special mats that can wear down over time and can be at odds with architectural treatments for buildings such as, for example, marble floors, carpeting, and the like. Newer sensor technology can be utilized for detecting a person's presence in a certain location.

### BRIEF DESCRIPTION

According to one embodiment, an occupant detection system is provided. The occupant detection system includes a controller and a plurality of floor contact sensors configured to collect sensor data from one or more predefined floor areas, wherein the controller is configured to determine a presence of a potential occupant based at least in part on the sensor data, wherein the sensor data includes a movement pattern of the potential passenger. The movement pattern of the potential occupant is analyzed to calculate a likelihood score that the potential occupant will use an occupancy area. And based at least in part on the likelihood score being above a threshold score, a confirmation signal is transmitted to an occupancy area controller.

In addition to one or more of the features described above, or as an alternative, further embodiments of the system may include an input device operable to provide access to the occupancy area.

In addition to one or more of the features described above, or as an alternative, further embodiments of the system may include that the occupancy area comprises an elevator car.

In addition to one or more of the features described above, or as an alternative, further embodiments of the system may include that the occupancy area comprises an escalator.

In addition to one or more of the features described above, or as an alternative, further embodiments of the system may include that at least one of the one or more predefined floor areas comprises an area adjacent to the occupancy area.

In addition to one or more of the features described above, or as an alternative, further embodiments of the system may include that the controller is further configured to transmit a cancellation signal to the occupancy area controller based at least in part on the likelihood score being below the threshold score.

In addition to one or more of the features described above, or as an alternative, further embodiments of the system may include that the input device comprises a kiosk.

In addition to one or more of the features described above, or as an alternative, further embodiments of the system may include that the one or more predefined floor areas comprises a floor area defined as a corridor between the kiosk and the occupancy area.

In addition to one or more of the features described above, or as an alternative, further embodiments of the system may include that the controller is further configured to receive, from the input device, a request to access the occupancy area. Receive, from the plurality of floor contact sensors, sensor data comprising movement patterns within the one or more predefined floor areas. Determine a presence of one or more potential occupants based at least in part on the movement patterns. Calculate a number of potential occupants based at least in part on the movement patterns and transmit the number of potential occupants to the occupancy area controller.

In addition to one or more of the features described above, or as an alternative, further embodiments of the system may include that the occupancy area controller is configured to provide access to the occupancy area based on the number of potential passengers.

In addition to one or more of the features described above, or as an alternative, further embodiments of the system may include an additional occupancy area and wherein the occupancy area controller is configured to provide access to the occupancy area and the additional occupancy area based on the number of potential occupants exceeding a passenger threshold.

In addition to one or more of the features described above, or as an alternative, further embodiments of the system may include that the plurality of floor contact sensors are located in a flooring or under a flooring of the one or more predefined floor areas.

According to one embodiment, a method for controlling an elevator system is provided. The elevator system includes an elevator car, an elevator controller, and a passenger detection system, wherein the passenger detection system includes a plurality of floor contact sensors configured to collect sensor data from one or more predefined floor areas. The method includes receiving sensor data from the plurality of floor contact sensors. Determining a presence of a potential passenger based at least in part on sensor data, wherein the sensor data comprises a movement pattern of the potential passenger. Analyzing the movement pattern of the potential passenger to calculate a likelihood score that the potential passenger will use the elevator car and based at least in part on the likelihood score being above a threshold score, operating the elevator car.

In addition to one or more of the features described above, or as an alternative, further embodiments of the method may include that at least one of the one or more predefined floor areas comprises an area adjacent to the elevator car.

In addition to one or more of the features described above, or as an alternative, further embodiments of the method may include that the plurality of floor contact sensors are located in a flooring or under a flooring of the one or more predefined floor areas.

According to one embodiment, a method for controlling an escalator system is provided. The escalator system includes a passenger riding area defined by a continuous loop of steps, one or more balustrades, and one or more handrails, a drive system, and a passenger detection system comprising a plurality of floor contact sensors configured to collect sensor data from one or more predefined floor areas. The method includes receiving sensor data from the plurality of floor contact sensors. Determining a presence of a potential passenger based at least in part on the sensor data, wherein the sensor data comprises a movement pattern of the potential passenger. Analyzing the movement pattern of the potential passenger to calculate a likelihood score that the potential passenger will use the passenger riding area and based at least in part on the likelihood score being above a threshold score, operating the escalator system.

In addition to one or more of the features described above, or as an alternative, further embodiments of the method may include that operating the escalator system comprises selectively operating the drive system in one of a plurality of modes, wherein the plurality of modes includes a first mode wherein the drive system operates at a first speed and a second mode wherein the drive system operates at a second speed.

In addition to one or more of the features described above, or as an alternative, further embodiments of the method may include operating the drive system in the second mode based at least in part on the likelihood score being below the threshold score.

In addition to one or more of the features described above, or as an alternative, further embodiments of the method may include that at least one of the one or more predefined floor areas comprises an area adjacent to the passenger riding area.

In addition to one or more of the features described above, or as an alternative, further embodiments of the method may include that the plurality of floor contact sensors are located in a flooring or under a flooring of the one or more predefined floor areas.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the disclosure;

FIG. 2 depicts a block diagram of a computer system for use in implementing one or more embodiments of the disclosure;

FIG. 3 depicts a block diagram of an elevator system according to one or more embodiments of the disclosure;

FIG. 4 depicts a flow diagram of a method for operating an elevator system according to one or more embodiments of the disclosure; and

FIG. 5 depicts a block diagram of an escalator control system according to one or more embodiments of the disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

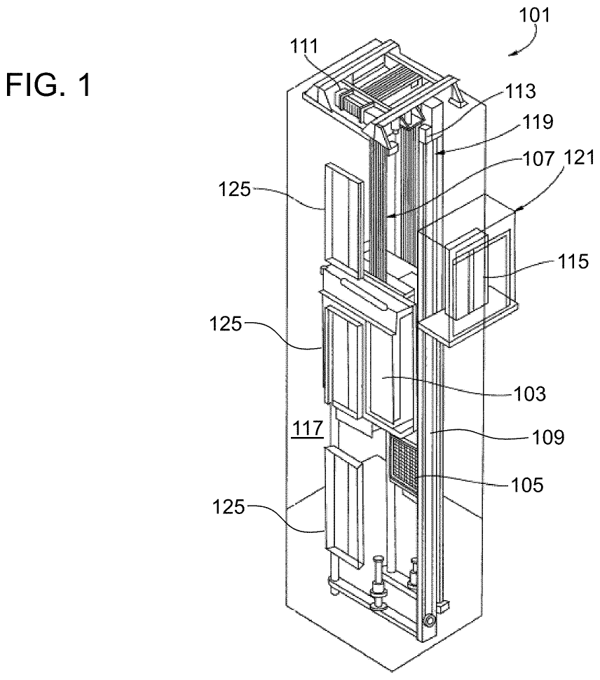

FIG. 1 is a perspective view of an elevator system 101 including an elevator car 103, a counterweight 105, a roping 107, a guide rail 109, a machine 111, a position encoder 113, and a controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position encoder 113. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor.

Although shown and described with a roping system, elevator systems that employ other methods and mechanisms of moving an elevator car within an elevator shaft, such as hydraulic and/or ropeless elevators, may employ embodiments of the present disclosure. FIG. 1 is merely a non-limiting example presented for illustrative and explanatory purposes.

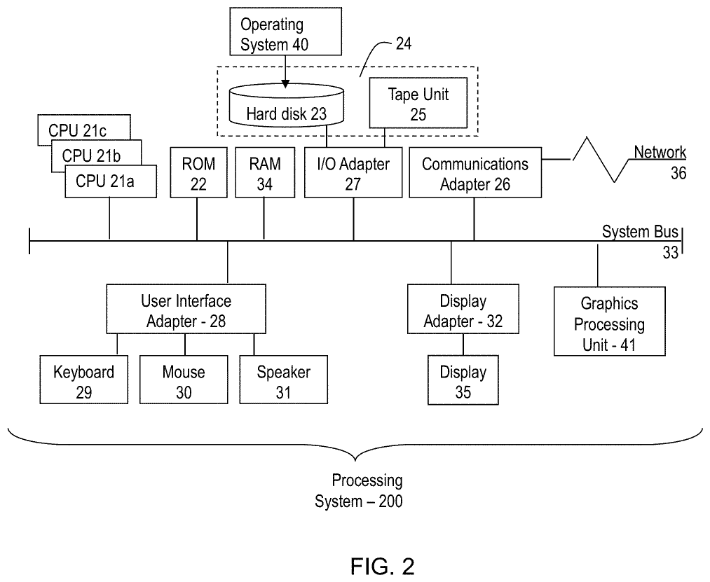

Referring to FIG. 2, there is shown an embodiment of a processing system 200 for implementing the teachings herein. In this embodiment, the system 200 has one or more central processing units (processors) 21a, 21b, 21c, etc. (collectively or generically referred to as processor(s) 21). In one or more embodiments, each processor 21 may include a reduced instruction set computer (RISC) microprocessor. Processors 21 are coupled to system memory 34 (RAM) and various other components via a system bus 33. Read only memory (ROM) 22 is coupled to the system bus 33 and may include a basic input/output system (BIOS), which controls certain basic functions of system 200.

FIG. 2 further depicts an input/output (I/O) adapter 27 and a network adapter 26 coupled to the system bus 33. I/O adapter 27 may be a small computer system interface (SCSI) adapter that communicates with a hard disk 23 and/or tape storage drive 25 or any other similar component. I/O adapter 27, hard disk 23, and tape storage device 25 are collectively referred to herein as mass storage 24. Operating system 40 for execution on the processing system 200 may be stored in mass storage 24. A network communications adapter 26 interconnects bus 33 with an outside network 36 enabling data processing system 200 to communicate with other such systems. A screen (e.g., a display monitor) 35 is connected to system bus 33 by display adaptor 32, which may include a graphics adapter to improve the performance of graphics intensive applications and a video controller. In one embodiment, adapters 27, 26, and 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 all interconnected to bus 33 via user interface adapter 28, which may include, for example, a Super I/O chip integrating multiple device adapters into a single integrated circuit.

In exemplary embodiments, the processing system 200 includes a graphics processing unit 41. Graphics processing unit 41 is a specialized electronic circuit designed to manipulate and alter memory to accelerate the creation of images in a frame buffer intended for output to a display. In general, graphics processing unit 41 is very efficient at manipulating computer graphics and image processing and has a highly parallel structure that makes it more effective than general-purpose CPUs for algorithms where processing of large blocks of data is done in parallel. The processing system 200 described herein is merely exemplary and not intended to limit the application, uses, and/or technical scope of the present disclosure, which can be embodied in various forms known in the art.

Thus, as configured in FIG. 2, the system 200 includes processing capability in the form of processors 21, storage capability including system memory 34 and mass storage 24, input means such as keyboard 29 and mouse 30, and output capability including speaker 31 and display 35. In one embodiment, a portion of system memory 34 and mass storage 24 collectively store an operating system coordinate the functions of the various components shown in FIG. 2. FIG. 2 is merely a non-limiting example presented for illustrative and explanatory purposes.

Turning now to an overview of technologies that are more specifically relevant to aspects of the disclosure, floor sensing technology can be utilized to detect the presence of a person at specific locations. In addition to detecting the presence of a person at a specific location, detecting the person's movement can be helpful when trying to anticipate a person's intent. In an escalator system, knowing that a passenger is about to ride the escalator can assist with operating the drive system on the escalator. For example, some escalator systems operate in low-power modes when there are no passengers riding the escalators. These escalator systems need to predict when a passenger will ride the escalator to change from a low-power mode to a normal operation mode. Also, elevator systems can use floor sensing technology to predict whether a passenger will ride in an elevator car.

Utilizing sensing technology, aspects of the present disclosure address the issue of predicting of a potential passenger's intent which is utilized to assist with operation of an escalator system, elevator system, and/or any other system. In one or more embodiments, passenger intent prediction can be utilized to increase passenger satisfaction with an elevator or escalator system. Additionally, power savings can be realized by predicting usage by potential passengers.

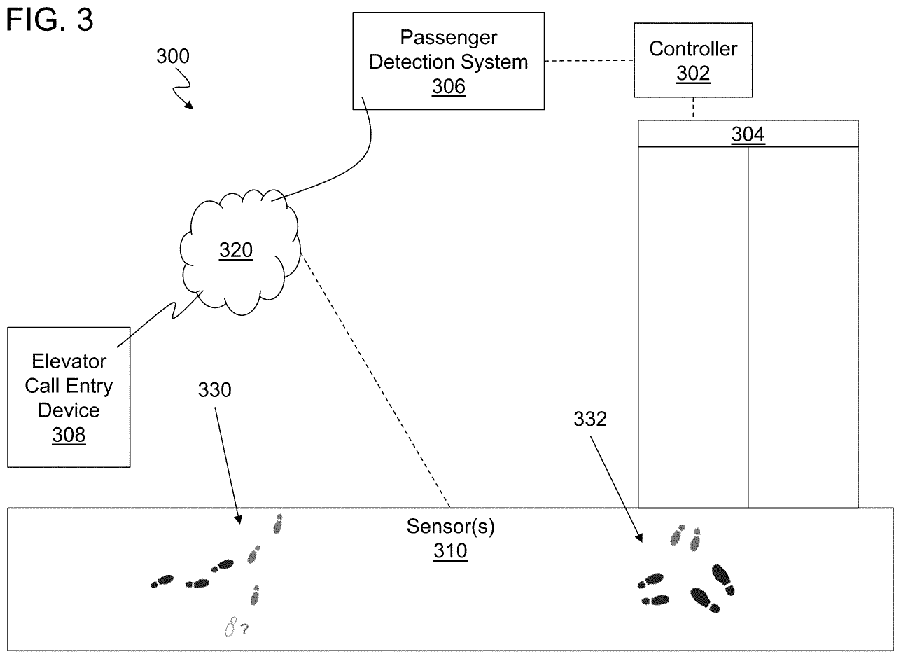

Turning now to a more detailed description of aspects of the present disclosure, FIG. 3 depicts an elevator system 300 according to one or more embodiments. The elevator system 300 includes a controller 302, an elevator car 304, a passenger detection system 306, an elevator call entry device 308, one or more floor sensors 310, and a network 320.

In one or more embodiments, the controller 302, passenger detection system 306, and elevator call entry device 308 can be implemented on the processing system 200 found in FIG. 2. Additionally, a cloud computing system can be in wired or wireless electronic communication with one or all of the elements of the system 300. Cloud computing can supplement, support or replace some or all of the functionality of the elements of the system 300. Additionally, some or all of the functionality of the elements of system 300 can be implemented as a node of a cloud computing system. A cloud computing node is only one example of a suitable cloud computing node and is not intended to suggest any limitation as to the scope of use or functionality of embodiments described herein.

In one or more embodiments, the system 300 utilizes the controller 302 to operate the elevator car 304. For example, when an elevator call is received from the elevator call entry device 308, the controller 302 can dispatch the elevator car 304 to a specific floor or the lobby of a building based on the elevator call. The controller 302 can also dispatch the elevator car 304 based on the detection of potential passengers within a predefined area of the building such as, for example, an elevator lobby. The potential passengers can be detected through the use of the floor contact sensors 310 in communication with the passenger detection system 306. The floor contact sensors 310 can collect sensor data about one or more potential passengers when they enter a predefined area. The predefined area can be an area adjacent to the elevator car 304 such as, for example, an elevator lobby. The sensor data can be analyzed by the passenger detection system 306 to calculate a likelihood score that a potential passenger will use the elevator car 304. If the likelihood score exceeds a threshold value, the passenger detection system 306 can send a confirmation signal to the controller 302 and the controller 302 can dispatch the elevator car 304 to the potential passenger. For example, a potential passenger may enter an elevator lobby and stop. This movement pattern can be analyzed to determine that the potential passenger is likely to use the elevator system and an elevator car 304 can be dispatched to the potential passenger based on this pattern. In one or more embodiments, the elevator car entry device 308 can be any device to provide access to the occupancy area such as swiping a card to get through a turnstile or access door. The elevator car entry device 308 can be a means to input a call to the passenger conveyance system (e.g., enter an elevator call) or a set of sensors (distinct from the floor contact sensors) such as video cameras, Bluetooth® sensors, etc. that provide other information such as identify (face recognition) or credentials (e.g., RFID badge).

In one or more embodiments, the sensors 310 can detect potential passengers and collect passenger details such as, for example, passenger counts, passenger movement speed, body orientation, and passenger intent. The passenger intent can be determined, for example, by movement patterns 330, 332 collected by the sensors 310. Movement pattern 330, in the illustrated example, shows a potential passenger entering a predefined area where the floor contact sensors 310 are located. The movement pattern 330 shows the potential passenger travelling towards the elevator car 304 and then changing direction. The changing direction can be determined, by the passenger detection system 306, based on step correlation as detected by the sensors 310. The passenger detection system 306 can include shape templates that correlate to potential passengers' feet or shoe shapes. The passenger detection system 306 can determine whether steps taken on the predefined areas correlate to one potential passenger moving through the area or if the steps correspond to multiple potential passengers moving through the area. The movement pattern 330, in the illustrated example, would likely not trigger the dispatch of the elevator car 304 by the elevator controller 302 because it appears the potential passenger was passing through the lobby. The other movement pattern 332, in the illustrative example, corresponds to three different passengers standing in a social pattern. As shown in the illustrated example, the sensors 310 detect the presence of three potential passengers whose orientations dictate a potential social grouping. This social grouping can indicate that these three passengers are a part of the same group and are waiting to go to the same floor when the elevator car 304 arrives. The passenger detection system 306 can send a confirmation signal to the elevator controller 302 to dispatch the elevator 304 for these three potential passengers. In one or more embodiments, multiple social patterns can be determined based on the grouping of movement patterns within the predefined areas. For example, if six people enter the elevator lobby and the social grouping shows that there are two groups of three people based on their movement patterns, the passenger detection system 306 can signal the controller 302 to send two separate elevator cars to the lobby. The passenger detection system 306 can determine the number of potential passengers and how they are grouped together to determine if two or more elevator cars need to be dispatched. If a social group is close to or exceeds an occupancy threshold, multiple elevator cars can be dispatched. For example, if twelve people enter the lobby and the occupancy threshold is eight, there might be a need for multiple elevator cars. If the social grouping shows a group of eight and a group of four, then the controller 302 can dispatch the two elevator cars.

In one or more embodiments, the passenger detection system 306 can determine passenger intent based on the collected floor contact data to show a passenger is associated with a grouping of passengers based on movement direction, gait, speed, and the like. For example, an individual passenger moving in the direction of a group of passengers can indicate the individual is associated with the group and likely to join on the elevator called for the group.

In one or more embodiments, a potential passenger can enter an elevator call at the elevator call entry device 308. The elevator call entry device 308 can be a button at or near the elevator car 304 or can be a kiosk near an elevator lobby. In one or more embodiments, passenger can enter an elevator call at the kiosk and the sensors 310 can detect the presence of the passenger at the kiosk. The kiosk can confirm the entry of the elevator call. In the case where there are multiple elevator cars, the kiosk can direct the passenger to a specific elevator car. In one or more embodiments, the passenger detection system 306 can determine based on the sensor data collected from the sensors 310 at the kiosk, a number of potential passengers. For example, while only one elevator call was received at the kiosk, often times multiple passengers can be present at the kiosk while only one passenger enters the elevator call. The number of passengers is determined by the passenger detection system 306 and confirmed based on the passenger movement patterns detected by the sensors 310. The number of passengers can be determined by counting the number of shoe print shapes detected by the sensors 310. In addition, passenger count can be determined by recognized shapes such as, for example, wheelchair wheel imprints on a floor surface detected by the sensors 310. The passenger detection system 306 can include template shapes for shoeprints, footprints, wheel imprints, walking aides (canes, walkers, etc.), and the like. These template shapes can be utilized to determine both the presence of a passenger and the number of passengers. These shape templates can also determine a disability of a passenger based on recognized imprints such as wheel chairs, crutches, canes, and walkers, for example. The recognized imprints in additional to shoe prints or foot prints can show a passenger utilizing assistive devices. The sensors 310 can be installed in an area defined by a travel corridor from the kiosk to the elevator lobby. The passenger detection system 306 can confirm the total number of passengers as they travel from the kiosk to a designated elevator car. If the number of passengers exceeds a passenger occupancy threshold, the passenger detection system 306 can signal the controller 302 to dispatch an additional elevator car to the lobby. The kiosk can then direct the passengers to each elevator car based on this total number of passengers. In one or more embodiments, the passenger detection system 306 can determine additional passenger characteristics such as movement speed. For example, if five passengers are present at the kiosk during an elevator call and the five passengers are moving towards the specified elevator car, the passenger detection system 306 can determine their movement speed to time the arrival of the elevator car 304. If one of the passengers moves slower than the rest of the passengers, the passenger detection system 306 can signal the controller 302 to hold the elevator car or even the elevator door open while waiting on the slower moving passenger. The speed of a passenger can be determined based on the collected sequence (e.g., time series) of shoe or foot prints detected by the sensors 310. The passenger detection system 306 can calculate a velocity of the passenger based on the shoe print movements. In one or more embodiments, besides a number of passengers, the space (volume) taken collectively by the people/objects inside the elevator can be determined. By studying the corner points of the cart the passenger detection system 306 can determine the amount of space taken. For the volume per person, this can be correlated with the shoe size or the stance (width between the two feet) or the weight from the sensors 310.

In one or more embodiments, the sensors 310 can be any type of floor contact sensors including but not limited to sensors that detects contact or proximity to the floor utilizing any means such as, for example, pressure, capacitance, acoustic, disruption of surface waves, and the like. The sensor 310 can be installed beneath the flooring or carpeting in a building area such as the elevator lobby. In one or more embodiments, the sensors 310 can include a Scanalytics SoleSensor®. The SoleSensor® is less than 1 mm thick and can be interconnected to cover a large floor area. An array of sensors 310 can be placed in an elevator or elevator lobby that provides multiple detection points, for example, oriented as a grid in an (x,y) plane, which make it possible to follow the direction of a person over time. There are numerous types of sensor technologies that are possible including pressure, capacitive, projected capacitive, acoustic, surface acoustic waves, acoustic pulse recognition, optical and thermal. Some types of sensors may be embedded in the flooring material itself, some may lay on top of the flooring, and some may lie under the flooring.

In one or more embodiments, the passenger detection system 306 can determine an identity of a passenger by analyzing the weight, gait detection, and the like. Additionally, passengers can be recognized even without establishing the identity of the passenger by detecting shoe size, shoe type, shoe brand, and the like. For example, it may be learned by previous elevator usage that a person with a particular shoe size, shoe type and gait typically calls an elevator to go to a particular destination floor. Hence, in the future, when a person with similar characteristics is detected, the elevator system will benefit by knowing that a call from a particular origin to a likely destination floor and could, for instance, hold an elevator that is already at the origin floor already intending to go to the destination floor to pick up the arriving passenger.

In one or more embodiments, the elevator car 304 includes sensors 310 that can determine the presence of passengers inside the elevator car 304. The sensors 310 inside the elevator car can be the same type or of a different type (e.g., optical light beam, load weight sensor, etc.) than the sensors 310 outside the elevator car 304. These sensors 310 can be utilized to confirm the passenger detection system 306 has predicted the correct number of passengers for the elevator car 304 prior to the dispatch of the elevator car 304. For example, if the passenger detection system 306 has predicted that four passengers were waiting for an elevator car 304, the sensors 310 on the elevator car 304 can confirm that four passengers have entered. The movement patterns 332 that predicted the four passengers can be saved in a database for usage at another time. Also, if the passenger detection system 306 predicts four passengers and the elevator car 304 confirms only three passengers entered the elevator car, the movement patterns are also saved in the database. A machine learning training model can be developed which utilizes a predictive algorithm. The movement patterns can be utilized as training data for tuning of this machine learning model and applied to future movement patterns to better predict passenger intent. The sensors 310 inside the elevator car (or passenger areas) can be utilized as a ground truth for machine learning of the passenger detection system 306. For example, if certain patterns show a higher percentage of using the elevator, this movement pattern can be used as training to better predict passenger intent.

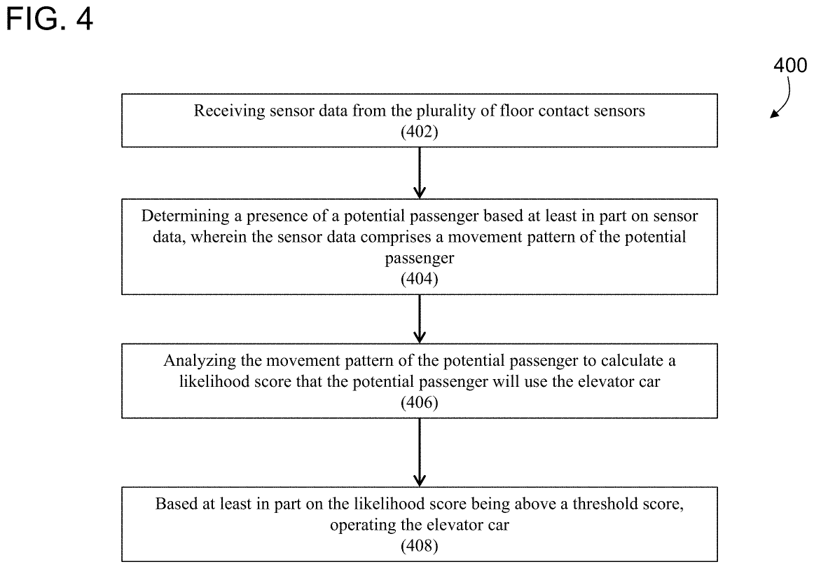

FIG. 4 depicts a flow diagram of a method for operating an elevator system according to one or more embodiments. The method 400 includes receiving sensor data from the plurality of floor contact sensors, as shown in block 402. And at block 404, the method 400 includes determining a presence of a potential passenger based at least in part on sensor data, wherein the sensor data comprises a movement pattern of the potential passenger. The method 400, at block 406, includes analyzing the movement pattern of the potential passenger to calculate a likelihood score that the potential passenger will use the elevator car. And at block 408, the method 400 includes based at least in part on the likelihood score being above a threshold score, operating the elevator car.

Additional processes may also be included. It should be understood that the processes depicted in FIG. 4 represent illustrations and that other processes may be added or existing processes may be removed, modified, or rearranged without departing from the scope and spirit of the present disclosure.

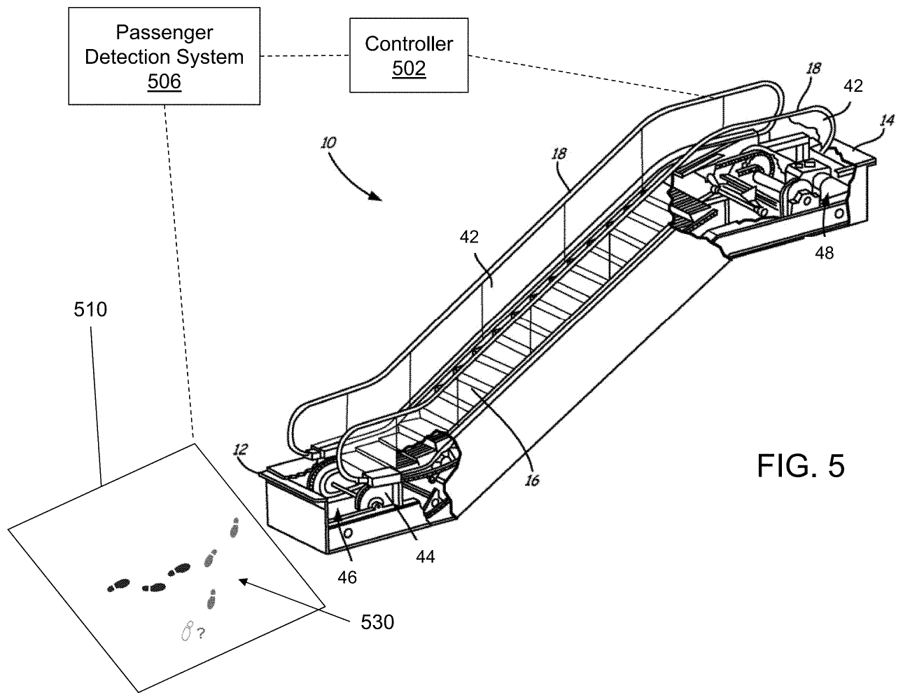

FIG. 5 depicts an escalator control system according to one or more embodiments. The escalator control system includes a controller 502, a passenger detection system 506, and a plurality of sensors 510. The escalator control system 500 also includes an escalator 10, which includes first landing 12, second landing 14, a continuous loop of steps 16, handrails 18, balustrades 42 defining a passenger riding area therebetween, drive system 44, and machine rooms 46, 48. Steps 16 extend from first landing 12 to second landing 14. Balustrades 22 extend along the side of steps 16 from first landing 12 to second landing 14, and handrails 18 are slidingly engaged with each balustrade 22. Drive system 44 is configured to drive steps 16 and handrails 18 at a constant speed and in synchrony with one another. A first portion of drive system 24 is located in machine room 46 and a second portion of drive system 44 is located in machine room 48. The escalator 10 is merely a non-limiting example presented for illustrative and explanatory purposes.

In one or more embodiments, the escalator controller 502 is configured to operate the escalator 10 in multiple modes. One mode can be a low power or off mode when the escalator 10 is not in use. This mode is utilized during non-peak usage times to save power costs. A second mode can be normal operation mode which can be utilized when there are passengers using the escalator 10. A third mode can be a heavy usage mode when there are a large number of passengers utilizing the escalator 10. These three modes, for example, can have different speeds of operation for the escalator 10. In the low power mode, the escalator 10 speed can be slower than in the normal operation mode.

In one or more embodiments, the controller 502 operates the escalator 10 in the different modes based on the presence of passengers as detected by the passenger detection system 506. The passenger detection system 506 utilizes sensors 510 located in predefined areas around the escalator. For example, the predefined floor areas can be adjacent to the escalator landing area. The passenger detection system 506 is operable to analyze sensor data collected from the sensors 510 to determine both the presence of a potential passenger and the passenger intent to use the escalator 10. The passenger intent can be derived from the passenger's movement pattern 530. The passenger movement pattern 530, in the illustrative example, shows a passenger's steps being tracked by the sensor 510 and analyzed by the passenger detection system 506. Based on the movement pattern 530, the passenger detection system 506 determines a likelihood score of the potential passenger using the escalator 10. If the likelihood score is above a threshold, the controller 502 will operate the escalator 10 in a certain mode such as, for example, normal operation mode. If the likelihood score does not exceed the threshold, the elevator controller 502 will not change the operation mode. In some cases, passengers may enter the predefined area adjacent to the escalator 10 but not board the escalator 10. For example, escalators are present in public buildings such as malls. A potential passenger might be crossing in front of an elevator landing but heading toward a store on the other side. In this instance, based on the movement pattern 530, the passenger detection system determines the passenger does not intend to ride the escalator 10 and the likelihood score will remain below the threshold. In one or more embodiments, the predefined floor areas can include the steps of the escalator as well as the landing and floor areas around the landing. Floor contract sensors can be located in the escalator steps as well.

In one or more embodiments, the escalator 10 can default to a low power mode when there are no passengers detected by the passenger detection system 506. Once a passenger is detected and the passenger intent is to use the escalator 10, the elevator controller switches the mode to normal operation mode. If a large wave of passengers are detected and are progressing towards the escalator 10, the controller 502 can operate the escalator 10 in a heavy usage mode which may increase the speed of the escalator 10 to get through the large wave of passengers. As the passengers exit the escalator 10, the controller 502 can change the mode of operation. The exiting of the passengers can also be detected by the passenger detection system 502. The movement patterns can indicate the passenger is exiting from the escalator 10 and moving away based on the sensor data collected. The passenger detection system 506 can determine a passenger has entered and exited the escalator 10 by matching the foot or show patterns collected by the sensors 510. The sensors 510 can be located adjacent to the entry and the exit of the escalator 10.

In one or more embodiments, the sensors 510 can be any type of floor contact sensors including but not limited to sensors that detects contact or proximity to the floor utilizing any means such as, for example, pressure, capacitance, acoustic, disruption of surface waves, and the like. An array of sensors 510 can be placed in at or near the escalator entrance or exit in predefined areas. The sensors 510 can be installed in a flooring or under the flooring and/or carpet in the predefined areas. The array of sensors 510 can be placed in an detection area at or near the escalator entrance or exit that provides multiple detection points, for example, oriented as a grid in an (x,y) plane, which make it possible to follow the direction of a person over time. There are numerous types of sensor technologies that are possible including pressure, capacitive, projected capacitive, acoustic, surface acoustic waves, acoustic pulse recognition, optical and thermal. Some types of sensors may be embedded in the flooring material itself, some may lay on top of the flooring, and some may lie under the flooring. In one or more embodiments, the floor contact sensors can be different than the pressure-sensitive landing plates at the entrance of the escalator. Whereas a single pressure plate at the entrance of the escalator can only give a binary signal whether someone is near the escalator and, when activated, the controller 502 might only presume that a person is going to board the escalator. Consequently, the landing plate is small so not to be activated if someone is deboarding an adjacent escalator. By contrast, the passenger detection system 506 generates an array of data which the controller 502 can determine much richer information, such as a longer range of detection since it can distinguish if someone is heading toward the escalator or elevator (hence planning to board) versus someone is passing by or moving away from the entrance. The sensors 510 can provide more detailed information, such as the number of passengers, classification of other objects (carts, gurneys, wheelchairs, etc.) and even some distinguishing characteristics of some passengers.

In one or more embodiments, the passenger detection system 306, 506 described herein can be utilized for detecting and predicting passenger movements for additional application such as, for example, entry onto moving platforms, opening of automatic doors, and the like. In addition, the passenger detection system 306, 506 can be utilized for detecting and predicting passengers for trains, subways, and other vehicles. Also, the passenger detection system 306, 506 can determine potential occupants for buildings with automatic doors and the sensors 310 can be utilized to determine potential occupants trying to access the building or other occupancy areas.

Other embodiments include combining the use of the floor sensor system for predicting movement with other sensor systems that identify the occupants or objects. For instance, a user or object may be carrying an RFID tag or badge which can be detected by a RFID reader to identify the person or object. Similar types of identification systems with devices or beacons worn by the person or object include near-field communications and Bluetooth. Similarly, other types of sensor systems can recognize the person or object such as video cameras providing images for face recognition or bar codes for object recognition.

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An occupant detection system comprising:
a controller; and
a plurality of floor contact sensors configured to collect sensor data from one or more predefined floor areas, wherein the controller is configured to:
determine a presence of a potential occupant based at least in part on the sensor data, wherein the sensor data comprises a movement pattern of the potential passenger;
analyze the movement pattern of the potential occupant to calculate a likelihood score that the potential occupant will use an occupancy area;
based at least in part on the likelihood score being above a threshold score, transmitting a confirmation signal to an occupancy area controller.

2. The occupant detection system of claim 1, further comprising:
an input device operable to provide access to the occupancy area.

3. The occupant detection system of claim 1, wherein the occupancy area comprises an elevator car.

4. The occupant detection system of claim 1, wherein the occupancy area comprises an escalator.

5. The occupant detection system of claim 1, wherein at least one of the one or more predefined floor areas comprises an area adjacent to the occupancy area.

6. The occupant detection system of claim 1, wherein the controller is further configured to:
transmit a cancellation signal to the occupancy area controller based at least in part on the likelihood score being below the threshold score.

7. The occupant detection system of claim 2, wherein the input device comprises a kiosk.

8. The occupant detection system of claim 5, wherein the one or more predefined floor areas comprises a floor area defined as a corridor between the kiosk and the occupancy area.

9. The occupant detection system of claim 2, wherein the controller is further configured to:
receive, from the input device, a request to access the occupancy area;
receive, from the plurality of floor contact sensors, sensor data comprising movement patterns within the one or more predefined floor areas;
determine a presence of one or more potential occupants based at least in part on the movement patterns;
calculate a number of potential occupants based at least in part on the movement patterns; and
transmit the number of potential occupants to the occupancy area controller.

10. The occupant detection system of claim 9, wherein the occupancy area controller is configured to provide access to the occupancy area based on the number of potential passengers.

11. The occupant detection system of claim 9, further comprising:
an additional occupancy area; and
wherein the occupancy area controller is configured to provide access to the occupancy area and the additional occupancy area based on the number of potential occupants exceeding a passenger threshold.

12. The occupant detection system of claim 1, wherein the plurality of floor contact sensors are located in a flooring or under a flooring of the one or more predefined floor areas.

13. The occupant detection system of claim 1, further comprising one or more occupancy area sensors configured to collect occupancy sensor data from one or more predefined areas in the occupancy area; and wherein the controller is further configured to:
train a machine learning model based at least in part on the movement pattern of the potential occupant compared to the occupancy sensor data.

14. The occupant detection system of claim 1, wherein the movement pattern is determined based at least in part on a detected contact pattern of a person or object.

15. A method for controlling an elevator system, the elevator system comprising an elevator car, an elevator controller, and a passenger detection system, wherein the passenger detection system includes a plurality of floor contact sensors configured to collect sensor data from one or more predefined floor areas, the method comprising:
receiving sensor data from the plurality of floor contact sensors;
determining a presence of a potential passenger based at least in part on sensor data, wherein the sensor data comprises a movement pattern of the potential passenger;
analyzing the movement pattern of the potential passenger to calculate a likelihood score that the potential passenger will use the elevator car; and
based at least in part on the likelihood score being above a threshold score, operating the elevator car.

16. The method of claim 15, wherein at least one of the one or more predefined floor areas comprises an area adjacent to the elevator car.

17. The method of claim 15, wherein the plurality of floor contact sensors are located in a flooring or under a flooring of the one or more predefined floor areas.

18. A method for controlling an escalator control system, the escalator system comprising a passenger riding area defined by a continuous loop of steps, one or more balustrades, and one or more handrails, a drive system, and a passenger detection system comprising a plurality of floor contact sensors configured to collect sensor data from one or more predefined floor areas, the method comprising:
receiving sensor data from the plurality of floor contact sensors;
determining a presence of a potential passenger based at least in part on the sensor data, wherein the sensor data comprises a movement pattern of the potential passenger;
analyzing the movement pattern of the potential passenger to calculate a likelihood score that the potential passenger will use the passenger riding area;
based at least in part on the likelihood score being above a threshold score, operating the escalator system.

19. The method of claim 18, wherein operating the escalator system comprises:
selectively operating the drive system in one of a plurality of modes, wherein the plurality of modes includes:
a first mode wherein the drive system operates at a first speed; and
a second mode wherein the drive system operates at a second speed.

20. The method of claim 19, further comprising:
operating the drive system in the second mode based at least in part on the likelihood score being below the threshold score.
